(19) United States
(12) Patent Application Publication
(10) Pub. No.: US 2016/0203966 A1
(43) Pub. Date: Jul. 14, 2016

(54) REMOTE LASER ABLATION ELECTROSPRAY IONIZATION MASS SPECTROMETRY

(71) Applicants: Akos VERTES, Reston, VA (US); Laine COMPTON, Springfield, VA (US); Matthew POWELL, Westover, WV (US); Brent RESCHKE, Morgantown, WV (US); Jordan FRIEND, Morgantown, WV (US)

(72) Inventors: Akos Vertes, Reston, VA (US); Laine Compton, Springfield, VA (US); Matthew Powell, Westover, WV (US); Brent Reschke, Morgantown, WV (US); Jordan Friend, Morgantown, WV (US)

(73) Assignees: Protea Biosciences, Inc., Morgantown, WV (US); The George Washington University, Washington, DC (US)

(21) Appl. No.: 14/912,506

(22) PCT Filed: Aug. 26, 2014
(86) PCT No.: PCT/US14/52645

§ 371 Date: Feb. 17, 2016

Related U.S. Application Data
(60) Provisional application No. 61/869,909, filed on Aug. 26, 2013.

(51) Int. Cl. H01J 49/04; H01J 49/16

(52) U.S. Cl. CPC H01J 49/0463; H01J 49/165

(57) ABSTRACT

In various embodiments, a device may generally comprise a remote ablation chamber comprising an inlet and an outlet, a laser to deposit energy into a sample in the chamber to ablate the sample and generate ablation products in the chamber, a transport device in fluid communication with the outlet, an ionization source to ionize the ablation products to produce ions, and a mass spectrometer having an ion transfer inlet to capture the ions. The ablation products or the ions may be transported in a fluid stream from the ablation chamber through the transport device. The distance from the outlet of the ablation chamber to the ion transfer inlet may be from 1 cm to 10 m. Methods of making and using the same are also described.

### STATEMENT OF GOVERNMENTAL INTEREST

This invention was made with Government support under Grant No. 0719232 awarded by the National Science Foundation and Grant No. DEFG02-01ER15129 awarded by the U.S. Department of Energy. The government has certain rights in the invention.

### BACKGROUND

The apparatuses and methods described herein generally relate to laser ablation electrospray ionization (LAESI) mass spectrometry (LAESI-MS), and in particular, remote-LAESI-MS (rLAESI-MS), as well as methods of making and using the same.

LAESI-MS is an ambient ionization technique that has been utilized to analyze and chemically image complex mixtures, cell populations, tissues, and single cells. One of the drawbacks of conventional LAESI-MS is that sample ablation generally occurs within a few centimeters of the ion transfer inlet of the mass spectrometer. Conventional LAESI-MS may require increased analysis time, complexity, and/or cost of analyzing large odd-shaped samples (e.g., entire live plants, animals, or their organs or tissues, microbial cultures, biofilms, or surgical implants) and coupling other analytical tools, such as a research-grade microscope, during analysis. Accordingly, more efficient and/or cost-effective mass spectrometry devices and methods of making and using the same are desirable.

### DESCRIPTION OF THE DRAWINGS

The various embodiments described herein may be better understood by considering the following description in conjunction with the accompanying drawings.

FIGS. 1A-D include illustrations of ablation chambers according to various embodiments described herein.

FIGS. 2A-D include illustrations of mass spectrometry systems according to various embodiments described herein.

FIG. 3 includes a graph plotting signal intensity and carrier gas flow rate (L/min) for rLAESI-MS systems comprising a large ablation chamber according to various embodiments described herein.

FIG. 4 includes a graph plotting signal intensity and carrier gas flow rate (L/min) for rLAESI-MS systems comprising a small ablation chamber according to various embodiments described herein.

FIG. 5 includes a graph plotting signal intensity and carrier gas flow rate (L/min) for rLAESI-MS systems comprising a large ablation chamber according to various embodiments described herein.

FIG. 6 includes a graph plotting signal intensity and carrier gas flow rate (L/min) for rLAESI-MS systems comprising a small ablation chamber according to various embodiments described herein.

FIG. 7 includes representative LAESI mass spectrum of an A. thaliana leaf in a small ablation chamber according to various embodiments described herein.

FIGS. S1(a) and S1(b) include an image of an A. thaliana leaf (a) before rLAESI-MS and (b) after rLAESI-MS.

### DESCRIPTION OF CERTAIN EMBODIMENTS

As generally used herein, the articles “one”, “a”, “an” and “the” refer to “at least one” or “one or more”, unless otherwise indicated.

As generally used herein, the terms “including” and “having” mean “comprising”.

As generally used herein, the term “about” refers to an acceptable degree of error for the quantity measured, given the nature or precision of the measurements. Typical exemplary degrees of error may be within 20%, 10%, or 5% of a given value or range of values, Alternatively, and particularly in biological systems, the terms “about” refers to values within an order of magnitude, potentially within 5-fold or 2-fold of a given value.

All numerical quantities stated herein are approximate unless stated otherwise. Accordingly, the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this disclosure is intended to include all lower numerical limitations subsumed therein and any minimum numerical limitation recited in this disclosure is intended to include all higher numerical limitations subsumed therein. Accordingly, Applicants reserve the right to amend this specification, including the claims, to expressly recite any sub-range subsumed within the ranges expressly recited herein.

In the following description, certain details are set forth in order to provide a better understanding of various embodiments of ionization sources for mass spectrometers and methods for making and using the same. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

This disclosure describes various features, aspects, and advantages of various embodiments of ionization sources for mass spectrometers and methods for making and using the same. It is understood, however, that this disclosure embraces numerous alternative embodiments that may be accomplished by combining any of the various features, aspects, and advantages of the various embodiments described herein in any combination or sub-combination that one of ordinary skill in the art may find useful. Such combinations or sub-combinations are intended to be included within the scope of this specification. As such, the claims may be amended to recite any features or aspects expressly or inherently described in, or otherwise expressly or inherently supported by, the present disclosure. Further, Applicants reserve the right to amend the claims to affirmatively disclaim any features or aspects that may be present in the prior art. The various embodiments disclosed and described in this disclosure may comprise, consist of, or consist essentially of the features and aspects as variously described herein.

According to certain embodiments, more efficient and/or cost-effective mass spectrometry devices and methods of making and using the same are described.

Laser ablation electrospray ionization mass spectrometry may be generally described in the following U.S. Patents and U.S. Patent Applications: U.S. Pat. No. 7,964,843, entitled “Three-dimensional molecular imaging by infrared laser ablation electrospray ionization mass spectrometry”, which issued on Jun. 21, 2011; U.S. Pat. No. 8,067,730, entitled “Laser Ablation Electrospray Ionization (LAESI) for Atmospheric Pressure, In Vivo, and Imaging Mass Spectrometry”, which issued on Nov. 29, 2011; U.S. Patent Application Publication No. 2010/0285446 entitled “Methods for Detecting Metabolic States by Laser Ablation Electrospray Ionization Mass Spectrometry”, which was filed on May 11, 2010; and U.S. Patent Application Publication No. 2012/0015345, now U.S. Pat. No. 8,551,706, entitled “Plume Collimation for Laser Ablation Electrospray Ionization Mass Spectrometry”, which was filed on Jul. 16, 2012.

Various embodiments of the rLAESI-MS described herein may provide certain advantages over other approaches of mass spectrometric analysis. Such advantages may include one or more of, but are not limited to, analysis of samples under a microscope, in situ and/or in vivo analysis of relatively large biological samples (living or non-living), and clinical tissue sampling. Additionally, various embodiments of the rLAESI-MS described herein may be universally coupled to conventional mass spectrometry platforms due to fewer mechanical and/or technical requirements for locating components and hardware in proximity to the mass spectrometer.

In various embodiments, the sample may comprise subcellular components, a single cell, cells, small cell populations, cell lines, tissues, organs, and/or entire living organisms. The single cell may have a smallest dimension less than 100 micrometers, such as less than 50 μm, less than 25 μm, and/or less than 10 μm. The single cell may have a smallest dimension from 1 μm to 100 μm, such as, for example, from 5 μm to 50 μm, and 10 μm to 25 μm. In various embodiments, the single cell may have a smallest dimension from 1 μm to 10 μm. The small cell population may comprise 10 cells to 1 million cells, such as 50 cells to 100,000 cells, and 100 cells to 1,000 cells. In various embodiments, the sample may comprise a liquid droplet. In various embodiments, the sample may comprise an aqueous droplet comprising subcellular components, a single cell, cells, small cell populations, cell lines, and/or tissues. In various embodiments, the sample may comprise subcellular components, a single cell, cells, small cell populations, cell lines, and/or tissues suspended in a liquid droplet. The sample may comprise a hydrophobic sample and/or a hydrophilic sample. The sample may comprise one of a solid sample, a liquid sample, and a solid suspended in an aqueous droplet.

In various embodiments, the sample may comprise water. For example, tissue, cells and subcellular components may comprise water. The sample may comprise a high, native water concentration. The sample may comprise a native water concentration. In various embodiments, the sample may comprise one of a cell and a small cell population suspended in an aqueous solution. The aqueous solution may comprise water, a buffer, such as, for example, HEPES or PBS, cell culture media, such as, for example, RPMI 1640, BME, and Ham's F-12, and/or any other suitable solution. The sample may comprise a rehydrated sample. The sample may comprise a dehydrated sample rehydrated with an aqueous solution. In various embodiments, the rehydrated sample may be rehydrated via an environmental chamber and/or an aqueous solution. The sample may comprise water and the laser energy may be absorbed by the water in the sample. The sample may be in a native environment and/or ambient environment.

In various embodiments, a device may generally comprise a remote ablation chamber comprising an inlet and an outlet, a laser to emit energy at a sample in the chamber to ablate the sample and generate ablation products in the chamber, a transport device in fluid communication with the outlet to transport the ablation products from the ablation chamber, an ionization source to ionize the ablation products exiting the transport device to produce ions, and a mass spectrometer having an ion transfer inlet to capture the ions. In various embodiments, a device may generally comprise a remote ablation chamber comprising an inlet and an outlet, a laser to emit energy at a sample in the chamber to ablate the sample and generate ablation products in the chamber, an ionization source to ionize the ablation products in or following the chamber, a transport device in fluid communication with the outlet to transport the ions from the ablation chamber to a mass spectrometer having an ion transfer inlet to capture the ions.

In various embodiments, the device may comprise a rLAESI-MS device as generally described herein. In various embodiments, the rLAESI-MS device may comprise a pulsed, mid-infrared laser and the ionization source may comprise an electrospray ionization source.

In various embodiments, the transport device may comprise at least one tube or conduit, an electrospray chip comprising channels, an aerodynamic amplifier, an aerodynamic separator, an aerodynamic focusing device, a dynamic merging device, and an ion funnel and combinations thereof. The transport device may comprise a conduit with an inner diameter from 0.1 mm to 10 mm and a length from 1 cm to 10 m.

In various embodiments, the ablation chamber may comprise a cross-sectional shape selected from a circle, an ellipse, an ellipsoid, a cone, a polygon, a curve, and combinations thereof. The ablation chamber may comprise a volume from 0.1 cm³ to 1000 cm³. The ablation chamber may comprise one of an open design and a closed design. The ablation chamber may be comprise glass, ceramic, metal or polymer, or combinations thereof. In various embodiments, the laser may emit energy at the sample in the chamber through at least a portion of the chamber that is transparent to the laser energy. The inlet of the ablation chamber may have a width of 10 mm or less and the outlet may have a width of up to 100 mm.

In various embodiments, the ablation chamber may comprise a sample platform. The sample platform may be at the bottom of the ablation chamber. The sample platform may be raised from the bottom of the ablation chamber from 0.1 mm to 50 mm. In various embodiments, the inlet, outlet, and sample may be co-axial or off-axis.

In various embodiments, the ionization source may be selected from an electrospray ionization source, an atmospheric pressure photoionization (APPI) source, and an atmospheric pressure chemical ionization (APCI) source. The ionization source may emit an ionizing medium selected from an electrospray plume, a flux of ionizing photons, and a flux of ionizing chemical species, and combinations thereof, to ionize the ablation products. In at least one embodiment, the ionization source comprises an electrospray ionization source.

In various embodiments, the device may comprise an ionization region at an interface of the ionizing medium and ablation products exiting the transport device. The distance from the outlet of the ablation chamber to the ion transfer inlet may be from 1 cm to 10 m. The ablation chamber and/or ionization region may independently have a temperature from −45° C. to 200° C. The ablation chamber and/or ionization region may independently have a pressure from 0.0001 atm to 80 atm. The ablation chamber and/or ionization region may independently have a relative humidity from 10% to 90%. In various embodiments, the temperature, pressure, and/or humidity of the ablation chamber may be independently different from the temperature, pressure, and/or humidity of the ionization region. The ablation chamber and/or ionization region may independently have a voltage of 0 V to 5000 V measured from the ground. In various embodiments, the ionizing medium may contact the ablation products exiting the transport device at an angle from 0° to 180° at the interface.

In various embodiments, the device may comprise a fluid supply in fluid communication with the inlet. The fluid supply may comprise a fluid stream to transport the ablation products from the ablation chamber through the transport device. The fluid supply may comprise a carrier gas selected from helium, argon, nitrogen, carbon dioxide, air, and combinations thereof. The carrier gas may have a flow rate from 0.1 L/min to 100.0 L/min. The fluid supply may comprise a supercritical fluid selected from carbon dioxide, methanol, ethanol, acetone and combinations thereof. The fluid stream may comprise a laminar flow, a turbulent flow, a transitional flow, and combinations thereof. The flow rate of the fluid stream may be configured to provide the laminar flow, a turbulent flow, a transitional flow, and combinations thereof. In various embodiments, the flow rate may vary during ablation.

In various embodiments, the device may comprise a filter and/or a cyclone filter. The cyclone filter may comprises a coiled tube including from a partial turn (e.g., from greater than 0 to less than 100% of a full turn) to 20 turns in the coil and wherein the coil has a diameter from 1 mm to 100 mm. The cyclone filter may filter components of the ablation products by centrifugal force.

In various embodiments, the ablation chamber may be sufficiently far (remote) from the mass spectrometer and/or inlet of the mass spectrometer to allow an optical microscope or other observation device to be implemented. In various embodiments, the device may comprise a microscope to generate an optical image of the sample.

In various embodiments, the laser may be selected from the group consisting of a UV laser, a laser emitting visible radiation, and an infrared laser, such as, for example, a mid-infrared laser. The UV laser may include, but is not limited to, an excimer laser, a frequency tripled Nd:YAG laser, a frequency quadrupled Nd:YAG laser, and a dye laser. In various embodiments, the mid-infrared laser may comprise one of an Er:YAG laser and a Nd:YAG laser driven optical parametric oscillator (OPO). The mid-infrared laser may operate at a wavelength from 2600 nm to 3450 nm, such as 2800 nm to 3200 nm, and 2930 nm to 2950 nm. The laser may comprise a mid-infrared pulsed laser operating at a wavelength from 2600 nm to 3450 nm, in a pulse on demand mode, or with a repetition rate from 1 Hz to 5000 Hz, and a pulse length from 0.5 ns to 100 ns. In various embodiments, the mid-infrared laser may comprise a diode pumped or UV flash lamp pumped Nd:YAG laser-driven optical parametric oscillator (OPO) (Vibrant IR, Opotek, Carlsbad, Calif.) operating at 2940 nm, 10 Hz repetition rate, and 5 ns pulse length. In various embodiments, the laser may be selected from lasers emitting a wavelength at an absorption band of one of an OH group, a CH group, and/or a NH group. The laser may have a pulse length less than 100 nanoseconds. The laser may have a pulse length less than 1 picosecond.

In various embodiments, the focusing system may comprise one or more mirrors, one or more coupling lenses, and/or an optical fiber. The laser pulse may be steered by gold-coated mirrors (PF10-03-M01, Thorlabs, Newton, N.J.) and coupled into the cleaved end of the optical fiber by a plano-convex calcium fluoride lens (Infrared Optical Products, Farmingdale, N.Y.) having a focal length from 1 mm to 100 mm, such as 25 mm to 75 mm, and 40 mm to 60 mm. In at least one embodiment, the focal length of the coupling lens may be 50 mm. In certain embodiments, the optical fiber may comprise at least one of a GeO₂-based glass fiber, a fluoride glass fiber, and a chalcogenide fiber. In various embodiments, the optical fiber may comprise a germanium oxide (GeO₂)-based glass optical fiber (450 pm core diameter, HP Fiber, Infrared Fiber Systems, Inc., Silver Spring, Md.) and the laser pulse may be coupled into the optical fiber by a plano-convex CaF₂ lens (Infrared Optical Products, Farmingdale, N.Y.). A high-performance optical shutter (SR470, Stanford Research Systems, Inc., Sunnyvale, Calif.) may be used to select the laser pulses. One end of the optical fiber may be held by a bare fiber chuck (BFC300, Siskiyou Corporation, Grants Pass, Oreg.) attached to a five-axis translator (BFT-5, Siskiyou Corporation, Grants Pass, Oreg.) or a micromanipulator (MN-151, Narishige, Tokyo, Japan) to adjust the distance between the fiber tip and the sample.

In various embodiments, the device may comprise a visualization system. In various embodiments, the visualization system may comprise a video microscope system. The visualization system may comprise a 7× precision zoom optic (Edmund Optics, Barrington, N.J.), fitted with a 5× infinity-corrected long working distance objective lens (M Plan Apo 5×, Mitutoyo Co., Kanagawa, Japan) or a 10× infinity- corrected long working distance objective lens (M Plan Apo 10×, Mitutoyo Co., Kanagawa, Japan) and a CCD camera (Marlin F131, Allied Vision Technologies, Stadtroda, Germany).

In various embodiments, the device may comprise one of transmission geometry and reflection geometry. In reflection geometry, the laser and ablation products may be on the same side of the sample. For example, the laser may be positioned on one side of the sample and the ablation products may be generated on the same side. In transmission geometry, the laser may be positioned on a first side of the sample and the ablation products may be generated on a second side of the sample. For example, the laser may emit energy at the rear of the sample to generate ablation products on the front of the sample. In transmission geometry, at least a portion of the ablation products or at least a substantial portion of the ablation products may be on a side opposite from the laser, and at least a portion of the ablation products or no portion of the ablation products may be on the same side as the laser.

In various embodiments, a method of remote laser ablation ionization may generally comprise ablating a sample in a remote ablation chamber by a laser pulse to generate ablation products, generating a ionization medium by an ionization source, transporting the ablation products by a transport device from the ablation chamber to an ionization region, intercepting the ablation products and ionization medium at the ionization region to generate ions, and detecting the ions with a mass spectrometer. In various embodiments, the ionization may occur remote from the ablation. In various embodiments, the ionization may occur near the ablation event. In various embodiments, the ionization may occur near the ablation event wherein the ions are entrained by the carrier gas and transported to the inlet of the mass spectrometer for analysis. The ionization source may comprise a spray ionization source. The ionization source may comprise an electrospray ionization source, an atmospheric pressure photoionization (APPI) source, and an atmospheric pressure chemical ionization (APCI) source. The ionizing medium may comprise an electrospray plume, a flux of ionizing photons, and a flux of ionizing chemical species to ionize the ablation products. The method may comprise contacting the ionizing medium and ablation products at an angle from 0° to 180° at the interface. The method may comprise contacting the ionizing medium and ablation products exiting the transport device at an angle from 0° to 180° at the interface.

In various embodiments, the method may comprise rLAESI-MS. The method may comprise positioning the ablation chamber in a position remote from an ion transfer inlet of the mass spectrometer. The distance from an outlet of the ablation chamber to the ion transfer inlet of the mass spectrometer is 1 cm to 10 m. In various embodiments, the method may comprise transporting the ablation products in a fluid stream from the ablation chamber through the transport device to an outlet of the transport device. In various embodiments, the method may comprise transporting the ions in a fluid stream from the ablation chamber through the transport device to an outlet of the transport device.

In various embodiments, the fluid stream may comprise a laminar flow, a turbulent flow, a transitional flow, and combinations thereof. The method may comprise varying a flow rate of the fluid stream from 0.1 L/min to 100.0 L/min.

In various embodiments, the method may comprise simultaneously ablating the sample and varying the flow rate of the fluid stream.

In various embodiments, the method may comprise separating the components of the ablation products based on centrifugal forces.

In various embodiments, the method may comprise co-axially mixing the ablation products and ionization medium.

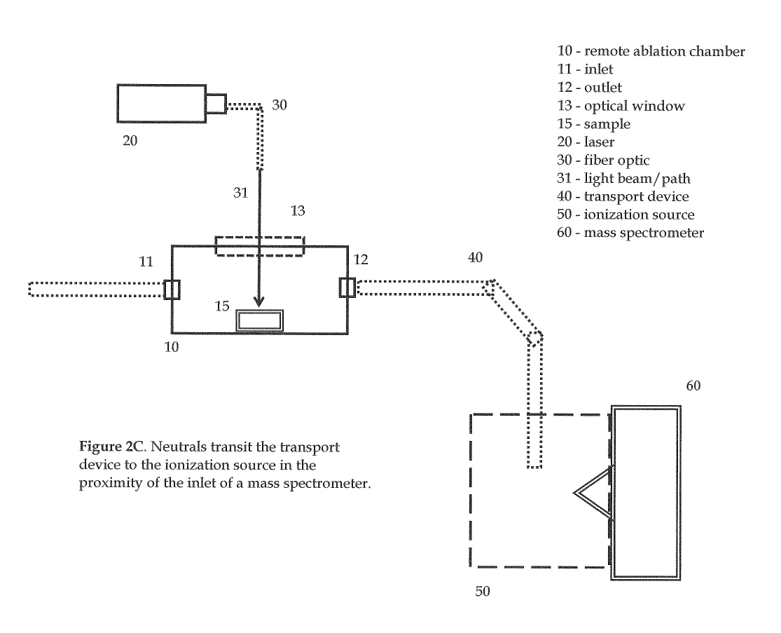

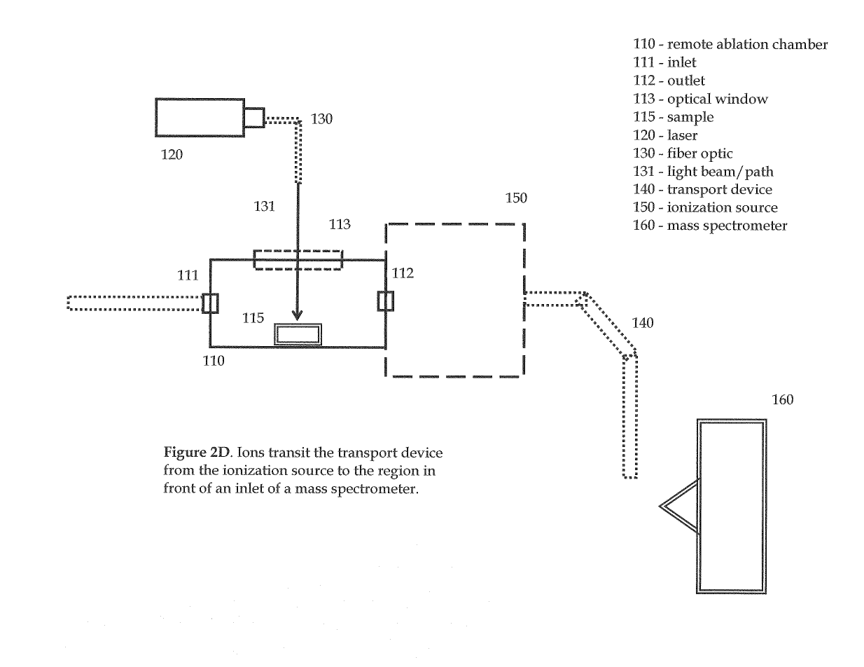

Referring to FIGS. 2C and 2D, in various embodiments, a rLAESI mass spectrometer device may comprise a mid-infrared laser, such as, for example, a Nd:YAG laser driven optical parametric oscillator, a focusing system, a remote ablation chamber in fluid communication with a transport device, an ionization source, such as an electrospray apparatus comprising a syringe pump and a high voltage power supply, and a mass spectrometer. The device may comprise a recording device (not shown). The device may comprise one or more long distance video microscopes to visualize the sample when the sample is positioned for ablation.

Referring to FIG. 2C, in various embodiments, a device for mass spectrometry may comprise a remote ablation chamber 10 comprising an inlet 11, outlet 12, and optical window 13, a laser 20, a focusing system comprising an optical fiber 30 to focus/steer the light beam/path 31 through the optical window 13, a transport device 40, an ionization source 50, and a mass spectrometer 60. In various embodiments, the transport device 40 may be intermediate the ablation chamber 10 and ionization source 50. Neutrals may exit the outlet 12 of the ablation chamber 10 into an inlet of the transport device 40 and transit to the ionization source 50 and/or ionization region proximal to an inlet of the mass spectrometer 60. In various embodiments, the ionization source 50 may be between the transport device 40 and mass spectrometer 60. In various embodiments, the ionization source 50 and/or ionization region may be adjacent or proximal to an inlet of the mass spectrometer 60.

Referring to FIG. 2D, in various embodiments, a device for mass spectrometry may comprise a remote ablation chamber 110 comprising an inlet 111, outlet 112, and optical window 113, a laser 120, a focusing system comprising an optical fiber 130 to focus/steer the light beam/11 path 131 through the optical window 113, a transport device 140, an ionization source 150, and a mass spectrometer 160. In various embodiments, the transport device 140 may be intermediate the ionization source 150 and inlet to the mass spectrometer 160. Ions may exit the ionization source 150 into an inlet of the transport device 140 and transit to the region proximal to an inlet of the mass spectrometer 160. In various embodiments, the ionization source 150 may be between the ablation chamber 120 and transport device 140.

The various embodiments described herein may be better understood when read in conjunction with the following representative examples. The following examples are included for purposes of illustration and not limitation.

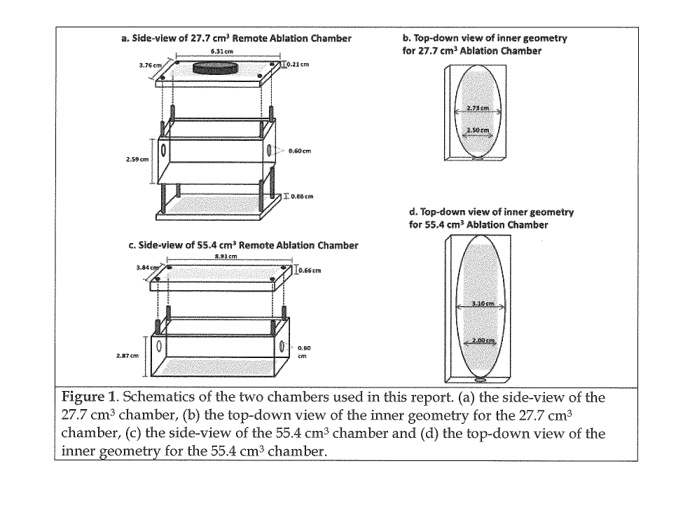

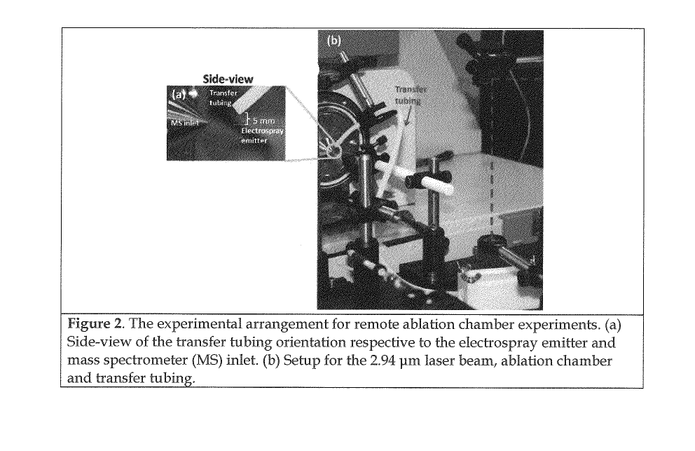

As shown in FIGS. 1A-1D, two ablation chambers were fabricated from acrylonitrile butadiene styrene (ABS) using a 3D printer at Protea Biosciences Group, Inc. in Morgantown, W.Va. As shown in FIGS. 1A and 1B, the volume of the first chamber is about 27.7 cm³ (small chamber) and the volume of the second chamber is about 55.4 cm³ (large chamber). A circular CaF₂ infrared (IR) window with anti-reflective coating was affixed to the top of the small chamber to allow the laser beam to enter the chamber and ablate the sample. As shown in FIGS. 1C and 1D, the top of the large chamber comprised a glass microscope slide to allow the laser beam to enter the chamber and ablate the sample. Each ablation chamber has a generally rectangular outer geometry and a generally elliptical inner geometry.

An optical parametric oscillator (OPO) (Vibrant IR or Opolette 100, Opotek, Carlsbad, Calif.) converted the output of a 10 Hz repetition rate Nd:YAG laser to mid- infrared laser pulses of about 5 ns pulse length and more than 4 mJ energy at about 2940 nm wavelength. Individual laser pulses were selected using a high performance optical shutter (SR470, Standford Research Systems, Inc., Sunnyvale, Calif.). In certain embodiments, beam steering and focusing were accomplished by gold coated mirrors (PF10-03-M01, Thorlabs, Newton, N.J.) and a single 75 mm focal length plano-convex antireflection-coated ZnSe lens or a 150 mm focal length plano-convex CaF₂ lens (Infrared Optical Products, Farmingdale, N.Y.). In certain embodiments, beam steering and focusing were accomplished by a sharpened germanium oxide (GeO₂) optical fiber having a core diameter of 450 pm and a tip radius of curvature of 15 pm to 50 μm (HP Fiber, Infrared Fiber Systems, Inc., Silver Spring, Md.). The optical fiber was held in a bare fiber chuck (BFC300, Siskiyou Corp., Grant Pass, Oreg.) that was attached to a five-axis translator (BFT-5, Siskiyou Corporation, Grants Pass, Oreg.). In certain embodiments, beam steering and focusing may be accomplished by a hollow waveguide having a 300 nm bore diameter manufactured by Polymicro Technologies, LLC. A 50 mm focal length plano-convex CaF₂ lens (Infrared Optical Products, Farmingdale, N.Y.) may focus the laser pulse onto the distal end of the optical fiber or hollow waveguide.

The electrospray system comprised a syringe pump (SP1001, World Precision Instruments, Sarasota, Fla.) to feed a 50% (v/v) aqueous methanol solution containing 0.1% (v/v) acetic acid at 1.0-2.0 μL/min flow rate through a tapered stainless steel emitter comprising a tapered tip having an outside diameter of 320 μm and an inside diameter of 100 pm. (MT320-100-5-5, New Objective Inc., Woburn, Mass.). Stable high voltage was generated by a regulated power supply (PS350, Stanford Research Systems, Inc., Sunnyvale, Calif.). The regulated power supply provided +3,300 to 3,400 V directly to the emitter. A liquid sample of 10⁴ M verapamil was placed at the bottom of the ablation chamber.

An AccuTOF mass spectrometer (JMS-T1000LC, JEOL USA Inc., Peabody, Mass.) collected and analyzed the ions generated by the rLAESI source. No sample related ions were observed when the laser was off. The electrospray solvent spectra were subtracted from the LAESI spectra using the JEOL Mass Center Spectrum Viewer (JEOL USA Inc., Peabody, Mass.).

In certain embodiments, a video microscope having a 7× precision zoom optic (Edmund Optics, Barrington, N.J.), a 2× infinity-corrected objective lens (M Plan Apo 2×, Mitutoyo Co., Kanagawa, Japan), and a CCD camera (Marlin F131, Allied Vision Technologies, Stadtroda, Germany) may be positioned above or on the side of the chamber to visualize the sample.

As shown in FIG. 2, a 45.7 cm segment of polytetrafluoroethylene (PTFE) tubing having a 4 mm inner diameter (Grainger Inc., Robbinsville, N.J.) was used to transfer neutrals ablated from the sample from the ablation chamber to the electrospray plume using nitrogen as a carrier gas that was regulated by a gas flow meter (023-92-ST #5 Flow Meter, Aalborg, Orangeburg, N.Y.). The transferred neutrals were delivered to the apex of the expanding electrospray plume, ionized and entered the mass spectrometer for analysis.

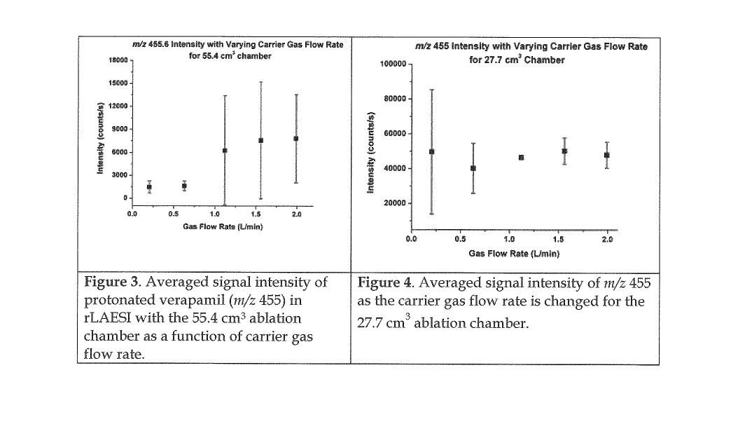

The averaged ion intensity of the protonated verapamil, [M⁺H]⁺, at m/z 455 in the large chamber is shown in FIG. 3. A liquid sample of 10⁻⁴ M verapamil was placed at the bottom of the ablation chamber. The nitrogen carrier gas flow rate was varied from 0.21 L/min to 2.0 L/min. Flow rates above 2.0 L/min are not shown due to the deposited sample being blown away by the carrier gas. Three replicates were averaged for flow rates 0.21 L/min and 0.63 L/min. Six replicates are averaged for flow rates 1.1 L/min to 2.0 L/min. As the carrier gas flow rate is increased, the intensities of m/z 455 show an increase at 1.1 L/min and level to about 7,000 counts/s at a flow rate of 2.0 L/min. Without wishing to be bound to any particular theory, it is believed that there is a threshold flow rate for the efficient transport of the ablated material. Visual observation indicated that carrier gas flow rates of 2.4 L/min and 2.6 L/min during sample ablation at caused at least a portion of the deposited sample droplet to blow away. Thus, a flow rate from 1.1 L/min to 2.0 L/min does not seem to have an effect on the rLAESI signal in the large chamber.

FIG. 4 includes a representative ion intensity of protonated verapamil, [M⁺H]⁺, at m/z 455, in the small chamber for rLAESI experiments. The nitrogen carrier gas flow rate was varied from 0.21 L/min to 2.0 L/min. Compared to the large chamber, the intensity of the m/z 455 ion increased by a factor of seven relative to the small chamber. Without wishing to be bound to any particular theory, the confinement of the ablation plume in the small chamber may improve (1) the interaction of the ablation plume with the carrier gas, (2) transfer of ablated neutrals to the electrospray plume, and/or (3) signal intensity. The CaF₂ IR-window in the small chamber increases the efficiency of the ablation of the 100 μm verapamil solution which may also contribute to the increase in signal intensity. As with the large chamber, visual observation confirmed that during ablation inside the small chamber the deposited sample was also blown away at 2.4 L/min and 2.6 L/min carrier gas flow rates. As a result, the flow rate of the carrier gas in the small chamber may be up to 2.0 L/min.

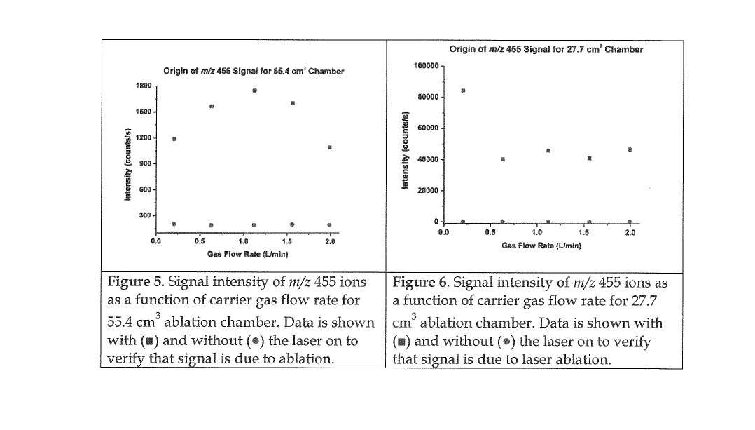

Referring to FIGS. 5 and 6, intensities for the m/z 455 ions using the small chamber and large chamber were measured to confirm that the observed mass spectra was due to laser ablation and not the carrier gas producing droplets from the liquid sample. When the electrospray and carrier gas were on and laser ablation occurred within the large chamber or small chamber, the signal for the verapamil molecular ion was present. When only the electrospray and carrier gas were on, no signal was observed for that ion. This shows that the carrier gas was not the cause of the observed verapamil signal, but instead a signal resulted from performing rLAESI-MS.

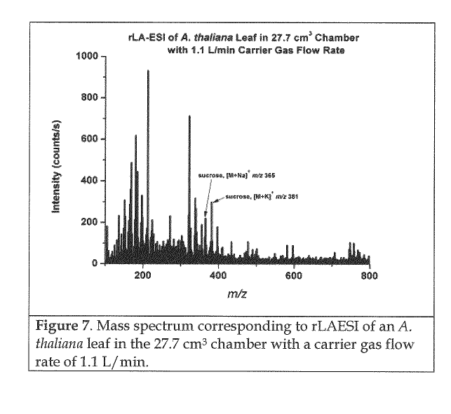

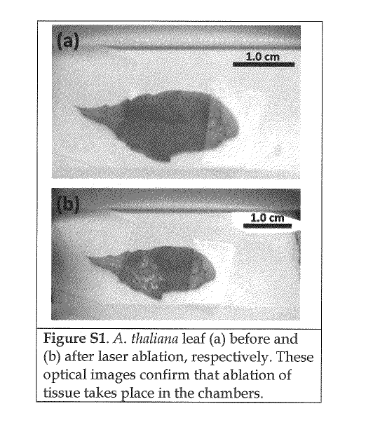

FIG. S1 shows an Arabidopsis thaliana leaf before rLAESI-MS (a) and after rLAESI-MS (b). The ends of the A. thaliana leaf are taped to the bottom of the large chamber. FIG. 7 shows a representative mass spectrum of an A. thaliana leaf produced by rLAESI in the small chamber using nitrogen as a carrier gas at a flow rate of 1.1 L/min. Tentative assignments of [sucrose+K]⁺ and [sucrose+Na]⁺, m/z 381 and 365 respectively, are indicated. The absolute intensity of the A. thaliana spectrum is quite low compared to the intensities presented in FIGS. 3 and 4. Spectrum intensity from the plant tissue was lower than the experiments with 100 verapamil.

Above a threshold, the carrier gas flow rates do not appreciably influence ion intensities for either die small chamber or the large chamber. The chamber volumes themselves affect the m/z 455 ion intensity; the small chamber produced the higher intensity as well as the least variation between experimental runs. Additionally, the IR window on top of the small chamber enhances the ablation inside of the chamber which is a contributing factor to the higher signal intensity.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments of mass spectrometry have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

1-57. (canceled)

58. A device comprising:
a remote ablation chamber comprising an inlet and an outlet;
a laser to emit energy at a sample in the ablation chamber to ablate at least a portion of the sample and generate ablation products in the chamber;
a transport device comprising an inlet in fluid communication with the outlet of the ablation chamber to transport the ablation products from the ablation chamber to an outlet of the transport device;
an ionization source to emit an ionizing medium to ionize the ablation products exiting the outlet of the ablation chamber to generate ions; and
a mass spectrometer having an ion transfer inlet to capture the ions exiting the outlet of the transport device.

59. The device of claim 58 comprising an ionization region at an interface of the ionizing medium and ablation products, wherein the ionization region is proximal to the outlet of the transport device.

60. The device of claim 58 comprising an ionization region at an interface of the ionizing medium and ablation products, wherein the ionization region is proximal to the inlet of the transport device.

61. The device of claim 59, wherein the ionizing medium contacts the ablation products at an angle from 0° to 180° at the interface.

62. The device of claim 58, wherein a distance from the outlet of the ablation chamber to the ion transfer inlet is 1 m to 8 m.

63. The device of claim 58 comprising a fluid supply in fluid communication with the inlet of the ablation chamber to transport at least one of the ablation products and ion through the transport device.

64. The device of claim 63, wherein the fluid supply comprises at least one of a carrier gas and a supercritical fluid, wherein the carrier gas is selected from helium, argon, nitrogen, carbon dioxide, air, and combinations thereof, and the supercritical fluid is selected from carbon dioxide, methanol, ethanol, acetone and combinations thereof.

65. The device of claim 64, wherein the carrier gas has a flow rate from 0.1 L/min to 10.0 L/min.

66. The device of claims 65, wherein the flow rate of the fluid supply is a transitional flow.

67. The device of claim 58, wherein the transport device comprises a conduit having an inner diameter from 0.1 mm to 10 mm and a length from 1 cm to 10 m.

68. The device of claim 58, wherein the transport device comprises a cyclone filter comprising a coiled tube including from a partial turn to 20 turns in the coil and wherein the coil has a diameter from 1 mm to 100 mm.

69. The device of claim 58, wherein the inlet, outlet, and sample are co-axial.

70. The device of claim 58, wherein the ablation chamber comprises a closed design.

71. The device of claim 58, wherein the inlet of the ablation chamber has a width of up to 10 mm and the outlet has a width of up to 100 mm.

72. The device of claim 58, wherein the ablation chamber has an inner cross-sectional shape of an ellipse, and a volume of 0.1 cm³ to 1000 cm³.

73. The device of claim 58, wherein the laser emits energy at the sample in the chamber through at least a portion of the chamber that is transparent to the laser energy.

74. The device of claim 58 comprising optical microscope positioned between the ablation chamber and mass spectrometer.
